(19) United States
(12) Patent Application Publication
(10) Pub. No.: US 2025/0081212 A1
(43) Pub. Date: Mar. 6, 2025

(54) METHODS AND APPARATUSES FOR SIDELINK POSITIONING

(71) Applicant: LENOVO (BEIJING) LIMITED, Beijing (CN)

(72) Inventors: Xiaodong YU, Beijing (CN); Haipeng LEI, Beijing (CN); Zhennian SUN, Beijing (CN); Jie HU, Beijing (CN); Xin GUO, Beijing (CN)

(21) Appl. No.: 18/724,074

(22) PCT Filed: Jan. 10, 2022
(86) PCT No.: PCT/CN2022/070957

§ 371 Date: Jun. 25, 2024

(51) Int. Cl. H04W 72/25; H04L 5/00

(52) U.S. Cl. CPC H04W 72/25; H04L 5/0048

(57) ABSTRACT

Embodiments of the present disclosure relate to methods and apparatuses for sidelink (SL) positioning. According to an embodiment of the present disclosure, a first user equipment (UE) can include: a transmitter configured to: transmit a first SL transmission to a plurality of second UEs, wherein the first SL transmission includes at least one of an identity (ID) associated with a number of second UE(s) of the plurality of second UEs or an indicator to enable or disable the plurality of second UEs to perform a condition based determination on whether to transmit a second SL transmission in response to the first SL transmission; and a receiver configured to: receive, from at least one second UE of the plurality of second UEs, at least one second SL transmission in response to the first SL transmission; and a processor coupled to the transmitter and the receiver.

### TECHNICAL FIELD

Embodiments of the present application generally relate to wireless communication technology, and especially to methods and apparatuses for sidelink (SL) positioning.

### BACKGROUND

SL positioning refers to transmitting positioning reference signal (PRS) over SL, which can operate independently of network or radio access technology (RAT) coverage and provide a new positioning method that fits new network use cases.

Service requirements for SL positioning have been defined in corresponding specifications, e.g., the requirements for Vehicle-to-Everything (V2X) and public safety use case can also apply to SL positioning. Based on the specified requirements, solutions for SL positioning need be studied to support “both in coverage,” “partial coverage” and “both out of coverage” scenarios.

In order to reduce traffic load while ensuring the measurement accuracy for SL positioning, it is desirable to further improve SL positioning reference signal (SL-PRS) transmission and measurement reporting.

### SUMMARY OF THE APPLICATION

Embodiments of the present application at least provide technical solutions for SL positioning.

According to some embodiments of the present application, a first user equipment (UE) may include: a transmitter configured to: transmit a first SL transmission to a plurality of second UEs, where the first SL transmission includes at least one of an identity (ID) associated with a number of second UE(s) of the plurality of second UEs or an indicator to enable or disable the plurality of second UEs to perform a condition based determination on whether to transmit a second SL transmission in response to the first SL transmission; and a receiver configured to: receive, from at least one second UE of the plurality of second UEs, at least one second SL transmission in response to the first SL transmission; and a processor coupled to the transmitter and the receive.

In some embodiments of the present application, the first SL transmission is request information to request an SL-PRS transmission, and each second SL transmission is an SL-PRS transmission.

In some embodiments of the present application, the request information is transmitted in sidelink control information (SCI).

In some embodiments of the present application, the first SL transmission includes an SL-PRS transmission and SCI associated with the SL-PRS transmission, each second SL transmission is a measurement report generated based on the SL-PRS transmission, and the at least one of the ID or the indicator is included in the SCI.

In some embodiments of the present application, the processor is configured to determine the ID or the number based on at least one of: a channel busy ratio (CBR) or a channel occupancy ratio (CR) associated with a resource pool measured by the first UE; a positioning accuracy level of the first UE; a reporting delay requirement for the first UE; or a number of second SL transmission(s) received by the first UE in response to a previous first SL transmission transmitted from the first UE.

In some embodiments of the present application, the condition based determination is performed based on at least one of: a CBR threshold or a CR threshold; a reference signal receiving power (RSRP) threshold; a distance threshold from the first UE; or an absolute location accuracy threshold.

According to some embodiments of the present application, a second UE may include: a receiver configured to: receive a first SL transmission from a first UE, where the first SL transmission includes at least one of an ID associated with a group of UEs or an indicator to enable or disable the second UE to perform a condition based determination on whether to transmit a second SL transmission in response to the first SL transmission; a processor coupled to the receiver and configured to: determine whether to transmit a second SL transmission in response to the first SL transmission; and a transmitter coupled to the processor.

In some embodiments of the present application, the first SL transmission is request information to request an SL-PRS transmission, and the second SL transmission is an SL-PRS transmission.

In some embodiments of the present application, the request information is received in SCI.

In some embodiments of the present application, the first SL transmission includes an SL-PRS transmission and SCI associated with the SL-PRS transmission, the second SL transmission is a measurement report generated based on the SL-PRS transmission, and the at least one of the ID or the indicator is included in the SCI.

In some embodiments of the present application, the first SL transmission includes the ID but does not include the indicator, and the processor is configured to: determine to transmit the second SL transmission when the second UE is included in the group of UEs; and determine not to transmit the second SL transmission when the second UE is not included in the group of UEs.

In some embodiments of the present application, the first SL transmission includes the indicator but does not include the ID, and the processor is configured to: in the case that the indicator enables the second UE to perform the condition based determination, determine to transmit the second SL transmission when a condition is met; and in the case that the indicator disables the second UE to perform the condition based determination, determine to transmit the second SL transmission.

In some embodiments of the present application, the first SL transmission includes both the indicator and the ID, and the processor is configured to: in the case that the indicator enables the second UE to perform the condition based determination, determine to transmit the second SL transmission when the second UE is included in the group of UEs and a condition is met; and in the case that the indicator disables the second UE to perform the condition based determination, determine to transmit the second SL transmission when the second UE is included in the group of UEs.

In some embodiments of the present application, the condition based determination is performed based on at least one of: a CBR threshold or a CR threshold; an RSRP threshold; a distance threshold from the first UE; or an absolute location accuracy threshold.

According to some other embodiments of the present application, a first UE may include: a processor configured to: initiate a channel occupancy time (COT) for transmitting a first SL transmission; a transmitter coupled to the processor and configured to: transmit the first SL transmission to a plurality of second UEs within the COT, where the first SL transmission includes indication information which indicates a remaining COT of the COT; and a receiver coupled to the processor and configured to: receive, within the remaining COT and from at least one second UE of the plurality of second UEs, at least one second SL transmission in response to the first SL transmission.

In some embodiments of the present application, the first SL transmission further includes request information to request an SL-PRS transmission, and each second SL transmission is an SL-PRS transmission.

In some embodiments of the present application, the first SL transmission is transmitted in SCI.

In some embodiments of the present application, the first SL transmission includes an SL-PRS transmission and SCI associated with the SL-PRS transmission, each second SL transmission is a measurement report generated based on the SL-PRS transmission, and the indication information is included in the SCI.

In some embodiments of the present application, the indication information is the remaining COT or a maximum number of UEs allowed to transmit a second SL transmission within the remaining COT.

According to some other embodiments of the present application, a second UE may include: a receiver configured to: receive a first SL transmission from a first UE, where the first SL transmission includes indication information which indicates a remaining COT of a COT initiated by the first UE; a processor coupled to the receiver and configured to: perform a one shot-based channel access procedure for a second SL transmission in response to the first SL transmission within the remaining COT; and a transmitter coupled to the processor and configured to: transmit the second SL transmission when the one shot-based channel access procedure is successful.

In some embodiments of the present application, the first SL transmission further includes request information to request an SL-PRS transmission, and the second SL transmission is an SL-PRS transmission.

In some embodiments of the present application, the first SL transmission is received in SCI.

In some embodiments of the present application, the first SL transmission includes an SL-PRS transmission and SCI associated with the SL-PRS transmission, the second SL transmission is a measurement report generated based on the SL-PRS transmission, and the indication information is included in the SCI.

In some embodiments of the present application, the indication information is the remaining COT or a maximum number of UEs allowed to transmit a second SL transmission within the remaining COT.

According to some embodiments of the present application, a method performed by a first UE may include: transmitting a first SL transmission to a plurality of second UEs, where the first SL transmission includes at least one of an ID associated with a number of second UE(s) of the plurality of second UEs or an indicator to enable or disable the plurality of second UEs to perform a condition based determination on whether to transmit a second SL transmission in response to the first SL transmission; and receiving, from at least one second UE of the plurality of second UEs, at least one second SL transmission in response to the first SL transmission.

In some embodiments of the present application, the first SL transmission is request information to request an SL-PRS transmission, and each second SL transmission is an SL-PRS transmission.

In some embodiments of the present application, the request information is transmitted in SCI.

In some embodiments of the present application, the first SL transmission includes an SL-PRS transmission and SCI associated with the SL-PRS transmission, each second SL transmission is a measurement report generated based on the SL-PRS transmission, and the at least one of the ID or the indicator is included in the SCI.

In some embodiments of the present application, the method may further include determining the ID or the number based on at least one of: a CBR or a CR associated with a resource pool measured by the first UE; a positioning accuracy level of the first UE; a reporting delay requirement for the first UE; or a number of second SL transmission(s) received by the first UE in response to a previous first SL transmission transmitted from the first UE.

In some embodiments of the present application, the condition based determination is performed based on at least one of: a CBR threshold or a CR threshold; an RSRP threshold; a distance threshold from the first UE; or an absolute location accuracy threshold.

According to some embodiments of the present application, a method performed by a second UE may include: receiving a first SL transmission from a first UE, where the first SL transmission includes at least one of an ID associated with a group of UEs or an indicator to enable or disable the second UE to perform a condition based determination on whether to transmit a second SL transmission in response to the first SL transmission; and determining whether to transmit a second SL transmission in response to the first SL transmission.

In some embodiments of the present application, the first SL transmission is request information to request an SL-PRS transmission, and the second SL transmission is an SL-PRS transmission.

In some embodiments of the present application, the request information is received in SCI.

In some embodiments of the present application, the first SL transmission includes an SL-PRS transmission and SCI associated with the SL-PRS transmission, the second SL transmission is a measurement report generated based on the SL-PRS transmission, and the at least one of the ID or the indicator is included in the SCI.

In some embodiments of the present application, the first SL transmission includes the ID but does not include the indicator, and the method may include: determining to transmit the second SL transmission when the second UE is included in the group of UEs; and determining not to transmit the second SL transmission when the second UE is not included in the group of UEs.

In some embodiments of the present application, the first SL transmission includes the indicator but does not include the ID, and the method may include: in the case that the indicator enables the second UE to perform the condition based determination, determining to transmit the second SL transmission when a condition is met; and in the case that the indicator disables the second UE to perform the condition based determination, determining to transmit the second SL transmission.

In some embodiments of the present application, the first SL transmission includes both the indicator and the ID, and the method may include: in the case that the indicator enables the second UE to perform the condition based determination, determining to transmit the second SL transmission when the second UE is included in the group of UEs and a condition is met; and in the case that the indicator disables the second UE to perform the condition based determination, determining to transmit the second SL transmission when the second UE is included in the group of UEs.

In some embodiments of the present application, the condition based determination is performed based on at least one of: a CBR threshold or a CR threshold; an RSRP threshold; a distance threshold from the first UE; or an absolute location accuracy threshold.

According to some other embodiments of the present application, a method performed by a first UE may include: initiating a COT for transmitting a first SL transmission; transmitting the first SL transmission to a plurality of second UEs within the COT, where the first SL transmission includes indication information which indicates a remaining COT of the COT; and receiving, within the remaining COT and from at least one second UE of the plurality of second UEs, at least one second SL transmission in response to the first SL transmission.

In some embodiments of the present application, the first SL transmission further includes request information to request an SL-PRS transmission, and each second SL transmission is an SL-PRS transmission.

In some embodiments of the present application, the first SL transmission is transmitted in SCI.

In some embodiments of the present application, the first SL transmission includes an SL-PRS transmission and SCI associated with the SL-PRS transmission, each second SL transmission is a measurement report generated based on the SL-PRS transmission, and the indication information is included in the SCI.

In some embodiments of the present application, the indication information is the remaining COT or a maximum number of UEs allowed to transmit a second SL transmission within the remaining COT.

According to some other embodiments of the present application, a method performed by a second UE may include: receiving a first SL transmission from a first UE, where the first SL transmission includes indication information which indicates a remaining COT of a COT initiated by the first UE; performing a one shot-based channel access procedure for a second SL transmission in response to the first SL transmission within the remaining COT; and transmitting the second SL transmission when the one shot-based channel access procedure is successful.

In some embodiments of the present application, the first SL transmission further includes request information to request an SL-PRS transmission, and the second SL transmission is an SL-PRS transmission.

In some embodiments of the present application, the first SL transmission is received in SCI.

In some embodiments of the present application, the first SL transmission includes an SL-PRS transmission and SCI associated with the SL-PRS transmission, the second SL transmission is a measurement report generated based on the SL-PRS transmission, and the indication information is included in the SCI.

In some embodiments of the present application, the indication information is the remaining COT or a maximum number of UEs allowed to transmit a second SL transmission within the remaining COT.

Embodiments of the present application provide technical solutions for SL positioning, which include but are not limited to apparatuses and methods for SL-PRS transmission and measurement reporting.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIGS. 2A and 2B illustrate two exemplary SL positioning architectures according to some embodiments of the present application;

FIGS. 3A and 3B illustrate two exemplary SL positioning architectures according to some embodiments of the present application;

FIG. 4 is a flow chart illustrating an exemplary method for SL positioning according to some embodiments of the present application;

FIG. 5 is a flow chart illustrating an exemplary method for SL positioning according to some other embodiments of the present application;

FIG. 6 is a flow chart illustrating an exemplary method for SL positioning according to some other embodiments of the present application;

FIG. 7 is a flow chart illustrating an exemplary method for SL positioning according to some other embodiments of the present application;

FIG. 8 illustrates an exemplary timing diagram for SL positioning according to some embodiments of the present application; and

FIG. 9 illustrates a simplified block diagram of an exemplary apparatus for SL positioning according to some embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order shown or in sequential order, or that among all illustrated operations to be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G (i.e., new radio (NR)), 3GPP long term evolution (LTE) and so on. Persons skilled in the art know very well that, with the development of network architecture and new service scenarios, the embodiments in the present application are also applicable to similar technical problems; and moreover, the terminologies recited in the present application may change, which should not affect the principle of the present application.

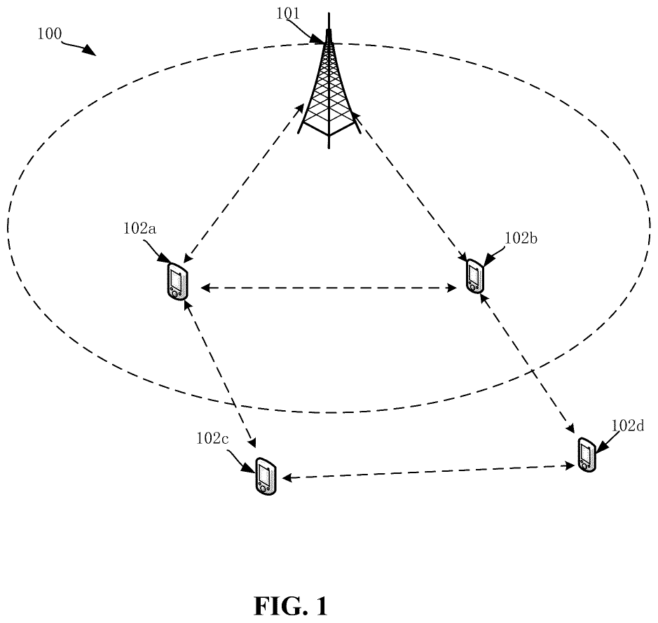

FIG. 1 is a schematic diagram illustrating an exemplary wireless communication system 100 according to some embodiments of the present application.

As shown in FIG. 1, the wireless communication system 100 includes at least one base station (BS) 101 and at least one UE (e.g., a UE 102a, a UE 102b, a UE 102c, and a UE 102d). Although one BS and four UEs are depicted in FIG. 1 for illustrative purpose, it is contemplated that any number of BSs and UEs may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

According to some embodiments of the present application, the UE 102a, the UE 102b, the UE 102c, and the UE 102d may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE. In an embodiment of the present application, the UE 102a may be a power-saving UE and the UE 102b may be a VUE. In another embodiment of the present application, both the UE 102a and the UE 102b may be VUEs or power-saving UEs.

According to some other embodiments of the present application, the UE 102a, the UE 102b, the UE 102c, and the UE 102d may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE 102a, the UE 102b, the UE 102c, and the UE 102d may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE 102a, the UE 102b, the UE 102c, and the UE 102d may include wearable devices, such as smart watches, fitness bands, optical head-mounted displays, or the like.

Moreover, a UE may be referred to as a subscriber unit, a mobile, a mobile station, a user, a terminal, a mobile terminal, a wireless terminal, a fixed terminal, a subscriber station, a user terminal, or a device, or described using other terminology used in the art.

Both the UE 102a and the UE 102b in the embodiments of FIG. 1 are in a coverage area of the BS 101, and may transmit information or data to the BS 101 and receive control information or data from the BS 101, for example, via LTE or NR Uu interface.

The UE 102c and the UE 102d are outside the coverage area of the BS 101. The UE 102a may communicate with the UE 102b and the UE 102c via SL (for example, via PC5 interface as defined in 3GPP standard documents), and the UE 102d may communicate with the UE 102b and the UE 102c via SL.

When a location service request is initiated or occurs at a UE, the UE (referred to as target UE or location service (LCS) target UE) needs to know its own position. When the target UE is within a coverage area of a BS or network (i.e., in coverage), the target UE may get positioning information from the BS or network, which is known as Uu positioning or NR Uu positioning. When the target UE is outside a coverage area of any BS or network (i.e., out of coverage), the target UE cannot get positioning information from any BS or network. According to various embodiments of the present disclosure, regardless of in coverage or out of coverage, the target UE (also referred to as SL target UE) may select one or more other UEs to be anchor UE(s) (also referred to as SL anchor UE(s)), which may participate in SL positioning and help the SL target UE to acquire its position, e.g., by sending/receiving SL PRS and doing relevant measurements. The SL anchor UE should have positioning capability, and may be a roadside unit (RSU) or any SL UE.

When performing SL positioning, the SL target UE and the SL anchor UE may be both in coverage (i.e., “both in coverage” scenario), or one in coverage and the other out of coverage (i.e., “partial coverage” scenario), or both out of coverage (i.e., “both out of coverage” scenario).

In an embodiment, the UE 102a may act as an SL target UE. The UE 102a may select the UE 102b to be an SL anchor UE to assist the UE 102a to acquire its position, which is in the “both in coverage” scenario. Alternatively or additionally, the UE 102a may select the UE 102c to be an SL anchor UE to assist the UE 102a to acquire its position, which is in the “partial coverage” scenario. It should be understood that the UE 102a may alternatively or additionally select other SL anchor UE(s) not shown in FIG. 1.

In an embodiment, the UE 102d may act as an SL target UE. The UE 102d may select the UE 102b to be an SL anchor UE to assist the UE 102d to acquire its position, which is in the “partial coverage” scenario. Alternatively or additionally, the UE 102d may select the UE 102c to be an SL anchor UE to assist the UE 102d to acquire its position, which is in the “both out of coverage” scenario. It should be understood that the UE 102d may alternatively or additionally select other SL anchor UE(s) not shown in FIG. 1. The SL anchor UE(s) selected by the UE 102d may be different from the SL anchor UE(s) selected by the UE 102a.

For sidelink transmission, resource allocation may be implemented by two modes, i.e., resource allocation mode 1 and resource allocation mode 2.

In the case of resource allocation mode 1, a sidelink transmission (e.g., a transmission of request for SL-PRS transmission, an SL-PRS transmission, or measurement reporting) is based on network scheduling, e.g., a sidelink transmission can be carried out by a UE if the UE has been provided with a valid scheduling grant by the network that indicates the exact set of resources used for the sidelink transmission. Resource allocation mode 1 may be used in the in-coverage scenario.

In the case of resource allocation mode 2, a sidelink transmission (e.g., a transmission of request for SL-PRS transmission, an SL-PRS transmission, or measurement reporting) is based on a UE's autonomously resource selection, e.g., a decision on sidelink transmission, including decision on the exact set of resources to be used for the sidelink transmission, is made by the transmitting UE (also referred to as Tx UE). Resource allocation mode 2 is applicable to both in-coverage and out-of-coverage scenarios.

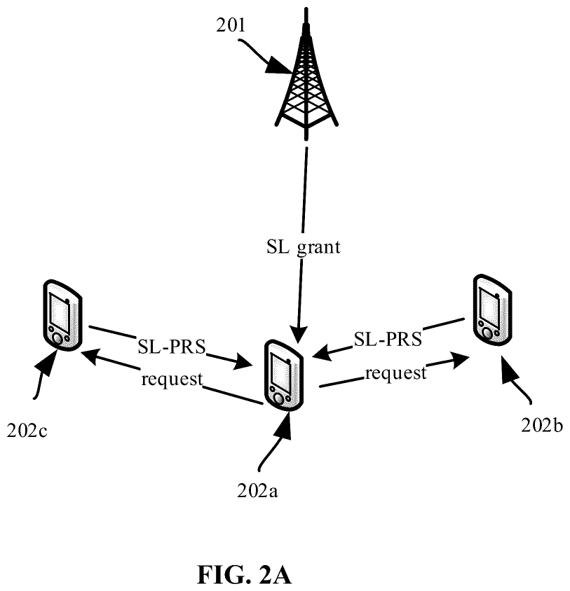

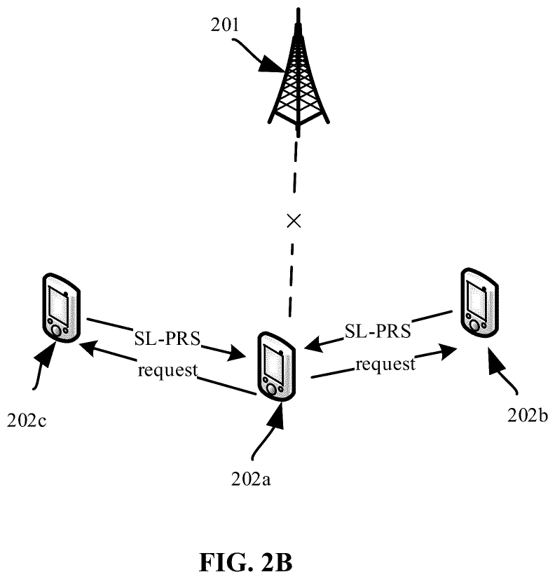

FIGS. 2A and 2B illustrate two exemplary SL positioning architectures according to some embodiments of the present application.

In FIG. 2A, a target UE may transmit a request to request SL-PRS transmission based on resource allocation mode 1 and receive SL-PRS transmissions from anchor UEs.

Specifically, referring to FIG. 2A, a UE 202a may be a target UE who wants to know its own position, and a UE 202b and a UE 202c may be two anchor UEs which help the UE 202a to acquire its position. The UE 202a may be in coverage of a BS 201. Accordingly, the UE 202a may request an SL grant from a network (e.g., the BS 201) for transmitting a request for SL-PRS transmission. After receiving the SL grant, the UE 202a may transmit a request on the resource(s) indicated by the SL grant to other UEs (e.g., the UE 202b and the UE 202c) in a groupcast manner or broadcast manner to request SL-PRS transmissions from the other UEs. After receiving the SL-PRS transmissions from the other UEs (e.g., the UE 302b and the UE 302c), the UE 202a may perform measurement on the SL-PRS transmissions to obtain measurement results, and then use the measurement results to calculate its position. Alternatively, after obtaining the measurement results, the UE 202a may transmit the measurement results to the network, such that the network may use the measurement results to calculate the UE 202a's position.

In FIG. 2B, a target UE may transmit a request to request SL-PRS transmission based on resource allocation mode 2 and receive SL-PRS transmissions from anchor UEs.

The difference between FIG. 2B and FIG. 2A lies in that: in FIG. 2B, the UE 202a (i.e., the target UE) is out of coverage of the BS 201, and thus it cannot receive the SL grant from the network. In such cases, the UE 202a may autonomously select resource(s) for transmitting the request to request SL-PRS transmissions from other UEs (e.g., the UE 202b and the UE 202c). After selecting the resource(s), the UE 202a may transmit a request on the selected resource(s) to other UEs (e.g., the UE 202b and the UE 202c) in a groupcast manner or broadcast manner to request SL-PRS transmissions from the other UEs. After receiving the SL-PRS transmissions from the other UEs, the UE 202a may perform measurement on the SL-PRS transmissions to obtain measurement results, and then use the measurement results to calculate its own position.

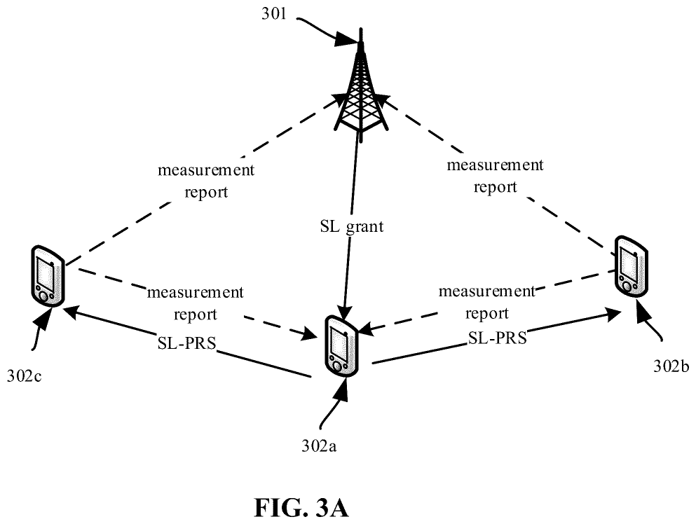

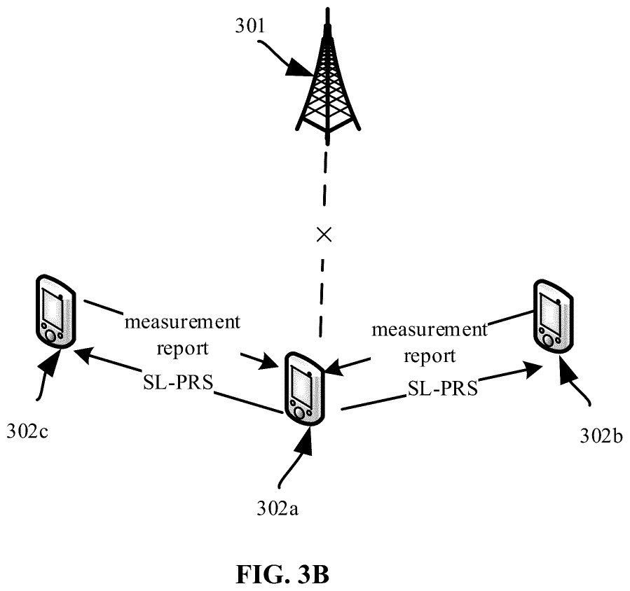

FIGS. 3A and 3B illustrate two exemplary SL positioning architectures according to some embodiments of the present application.

In FIG. 3A, a target UE may transmit an SL-PRS transmission based on resource allocation mode 1 and receive associated measurement reports from anchor UEs.

Specifically, referring to FIG. 3A, a UE 302a may be a target UE who wants to know its own position, and a UE 302b and a UE 302c may be two anchor UEs which help the UE 302a to acquire its position. The UE 302a may be in coverage of a BS 301. Accordingly, the UE 302a may request an SL grant from a network (e.g., the BS 301) for transmitting an SL-PRS transmission. After receiving the SL grant, the UE 302a may transmit the SL-PRS transmission on the resource(s) indicated by the SL grant to other UEs (e.g., the UE 302b and the UE 302c) in a groupcast manner or broadcast manner. After receiving the SL-PRS transmission, the other UEs (e.g., the UE 302b and the UE 302c) may perform measurement on the SL-PRS transmission and then transmit associated measurement reports (including measurement results) to the UE 302a. After receiving the measurement reports, the UE 302a may use the measurement results in the measurement reports to calculate its own position. Alternatively, after receiving the measurement reports, the UE 302a may transmit the measurement results in the measurement reports to the network, such that the network may use the measurement results to calculate the UE 302a's position. Alternatively, in the case that the other UEs (e.g., the UE 302b and the UE 302c) are in the coverage of the BS 301, the other UEs may transmit the measurement reports directly to the BS 301, such that the BS 301 may use the measurement results in the measurement reports to calculate the UE 302a's position.

In FIG. 3B, a target UE may transmit an SL-PRS transmission based on resource allocation mode 2 and receive associated measurement reports from anchor UEs.

The difference between FIG. 3B and FIG. 3A lies in that: in FIG. 3B, the UE 302a (i.e., the target UE) is out of coverage of the BS 301, and thus it cannot receive the SL grant from the network. In such cases, the UE 302a may autonomously select resource(s) for transmitting the SL-PRS transmission to other UEs (e.g., the UE 302b and the UE 302c). After selecting the resource(s), the UE 302a may transmit the SL-PRS transmission on the selected resource(s) to other UEs (e.g., the UE 302b and the UE 302c) in a groupcast manner or broadcast manner. After receiving the SL-PRS transmission, the other UEs (e.g., the UE 302b and the UE 302c) may perform measurement on the SL-PRS transmission and then transmit associated measurement reports (including measurement results) to the UE 302a. After receiving the measurement reports, the UE 302a may use the measurement results in the measurement reports to calculate its own position.

Although FIGS. 2A, 2B, 3A, and 3B illustrate two anchor UEs which transmit SL-PRS transmissions or measurement reports, it is contemplated that any number of anchor UEs may transmit the SL-PRS transmissions or measurement reports.

In some cases (e.g., the scenarios as shown in FIGS. 2A and 2B), a large number of UEs may receive the request for SL-PRS transmission from the target UE. If these large number of UEs are in resource allocation mode 1, they may transmit scheduling requests to the BS to request resources for transmitting the SL-PRS transmissions, which may increase potential uplink (UL) traffic load. If these large number of UEs are in resource allocation mode 2, they may autonomously select resources for transmit the SL-PRS transmissions, which may increase potential transmission collisions among these UEs. In addition, a large number of SL-PRS transmissions to the target UE may increase a traffic load of a resource pool.

In some other cases (e.g., the scenarios as shown in FIGS. 3A and 3B), a large number of UEs may receive the SL-PRS transmission from the target UE and may transmit measurement reports in response to the SL-PRS transmission. Similarly, if these large number of UEs are in resource allocation mode 1, they may transmit scheduling requests to the BS to request resources for transmitting the measurement reports, which may increase potential UL traffic load. If these large number of UEs are in resource allocation mode 2, they may autonomously select resources for transmit the measurement reports, which may increase potential transmission collisions among these UEs. In addition, a large number of measurement reports may increase a traffic load of a resource pool (if they are transmitted to the target UE) or increase UL traffic load (if they are transmitted to the BS).

Accordingly, how to reduce the traffic load and potential transmission collisions while satisfying the measurement accuracy requirement when performing SL positioning needs to be addressed.

Given this, embodiments of the present application propose technical solutions for SL positioning, which provide various methods for SL-PRS transmission and its associated measurement reporting. Accordingly, embodiments of the present application can reduce the traffic load and potential transmission collisions while satisfying the measurement accuracy requirement by limiting the number of UEs for SL-PRS transmission or limiting the number of UEs for measurement reporting. More details on embodiments of the present application will be described in the following text in combination with the appended drawings.

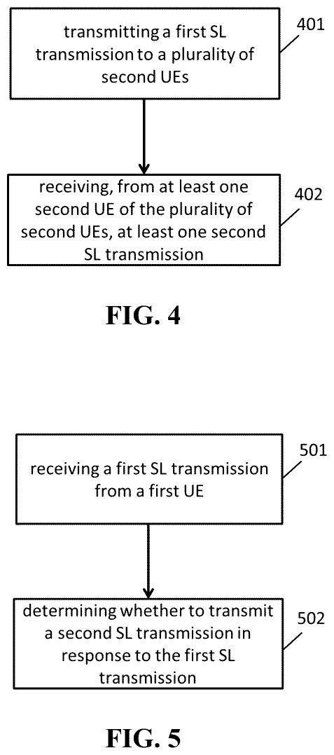

FIG. 4 is a flow chart illustrating an exemplary method for SL positioning according to some embodiments of the present application. The method illustrated in FIG. 4 may be performed by a first UE (e.g., a target UE at which a location service request is initiated or occurs, i.e., a UE that wants to know its own position). For example, the first UE may be the UE 102a, UE 102b, UE 102c, or UE 102d in FIG. 1, the UE 202a in FIG. 2A or FIG. 2B, or the UE 302a in FIG. 3A or FIG. 3B.

Referring to FIG. 4, in step 401, the first UE may transmit a first SL transmission to a plurality of second UEs, e.g., in a unicast manner, a broadcast manner, or a groupcast manner. The first SL transmission may include at least one of an ID associated with a number of second UE(s) of the plurality of second UEs or an indicator to enable or disable the plurality of second UEs to perform a condition based determination on whether to transmit a second SL transmission in response to the first SL transmission.

Then, in step 402, the first UE may receive at least one second SL transmission from at least one second UE of the plurality of second UEs in response to the first SL transmission. That is, from each of the at least one second UE, the first UE may receive a corresponding second SL transmission in response to the first SL transmission. Each of the at least one second UE may be referred to as an anchor UE which helps the first UE to acquire the first UE's position.

In some cases (e.g., the scenarios as shown in FIGS. 2A and 2B), the first SL transmission is request information to request an SL-PRS transmission, and each second SL transmission is an SL-PRS transmission.

That is, in such cases, the first UE may transmit request information to the plurality of second UEs in step 401. The request information may include at least one of an ID associated with a number of second UE(s) of the plurality of second UEs or an indicator to enable or disable the plurality of second UEs to perform a condition based determination on whether to transmit an SL-PRS transmission in response to the request information. Then, in step 402, the first UE may receive at least one SL-PRS transmission from at least one second UE of the plurality of second UEs.

In some embodiments of the present application, the request information may be transmitted in SCI. The SCI may include at least one of first stage SCI or second stage SCI as specified in 3GPP standard documents. Consequently, the request information may be transmitted in at least one of the first stage SCI or the second stage SCI.

According to some embodiments of the present application, the request information may include an ID associated with a number of second UE(s) and may not include the indicator to enable or disable the plurality of second UEs to perform a condition based determination on whether to transmit an SL-PRS transmission in response to the request information.

In some embodiments of the present application, the ID may be a source ID or a destination ID as specified in 3GPP standard documents. In such embodiments, the second UE(s) associated with the ID may refer to the second UE(s) which have the source ID or the destination ID.

In some other embodiments of the present application, a number of second UE(s) may be included in a group (or a set), and the ID associated with the number of second UE(s) may be a group ID of the group (or the set ID of the set) including the number of second UE(s).

In such embodiment, before step 401, the first UE and the plurality of second UEs may obtain configuration information for at least one group (or set), wherein each group (or set) may be associated with a respective number of second UE(s) and a respective service (or traffic) (e.g., positioning service). Accordingly, the configuration information for each group (or set) may indicate at least one of an ID of the group (or set), one or more second UEs included in the group (or set), or a service (or traffic) associated with the group (or set). In an embodiment, the configuration information may be configured by a network (e.g., BS). In another embodiment, the configuration information may be obtained based on higher layer (e.g., a layer higher than the physical layer) signaling exchanging among the first UE and the plurality of second UEs. After obtaining the configuration information, the first UE may know the number of second UEs included in each group (or set) and each of the plurality of second UEs may know the group(s) (or set(s)) it belongs to.

In some embodiments of the present application, before step 401, the first UE may determine the ID to be included in the request information based on at least one of:
A channel busy ratio (CBR) or a channel occupancy ratio (CR) associated with a resource pool measured by the first UE. The first UE may determine the CBR or the CR based on the methods as specified in 3GPP standard documents. For example, if the CBR or the CR is high, then the first UE may determine an ID associated with a small number of second UEs to be included in the request information.
A positioning accuracy level of the first UE. For example, if the positioning accuracy level of the first UE is low (e.g., the positioning accuracy level is low may mean that the positioning accuracy requirement is high), then the first UE may need more SL-PRS transmissions. Accordingly, the first UE may determine an ID associated with a larger number of second UEs to be included in the request information.
A reporting delay requirement for the first UE. In some embodiments, the reporting delay requirement for the first UE may be determined based on a positioning delay requirement of the first UE. For example, if the first UE allows a long positioning delay, then the first UE may receive more SL-PRS transmissions. Accordingly, the first UE may determine an ID associated with a larger number of second UEs to be included in the request information.
A number of SL-PRS transmission(s) received by the first UE in response to a previous request information transmitted from the first UE. For example, if the first UE received a small number of SL-PRS transmission(s) in response to a previous request information, in order to receive more SL-PRS transmissions, the first UE may determine an ID associated with a larger number of second UEs to be included in the request information.

Since each ID is associated with a respective number of second UE(s), the first UE may determine a number of second UE(s) from which the first UE intends to receive SL-PRS transmission(s) based on at least one of the above factors, and then determine the ID to be included in the request information based on the determined number.

After determining the ID to be included in the request information, in step 401, the first UE may include the determined ID in the request information and transmit the request information to the plurality of second UEs. According to some embodiments of the present application, only UEs associated with the ID (e.g., included in a group or set associated with the ID) will transmit an SL-PRS transmission in response to the request information, thereby limiting the number of UEs for SL-PRS transmission.

According to some other embodiments of the present application, the request information may include the indicator to enable or disable the plurality of second UEs to perform a condition based determination on whether to transmit an SL-PRS transmission in response to the request information and may not include the ID associated with a number of second UE(s). For example, the indicator may be a 1-bit field in the SCI. A value “0” of the field may indicate to disable the plurality of second UEs to perform a condition based determination on whether to transmit an SL-PRS transmission in response to the request information, such that each of the plurality of second UEs may determine whether to transmit the SL-PRS transmission regardless of its own condition. A value “1” of the field may indicate to enable the plurality of second UEs to perform a condition based determination on whether to transmit an SL-PRS transmission in response to the request information, such that each of the plurality of second UEs may determine whether to transmit the SL-PRS transmission based on its own condition, for example, it may determine to transmit the SL-PRS transmission when a condition is met and determine not to transmit the SL-PRS transmission when the condition is not met.

In some embodiments of the present application, the condition based determination is performed based on at least one of the following thresholds: a CBR threshold or a CR threshold; an RSRP threshold; a distance threshold from the first UE; or an absolute location accuracy threshold. For example, when a CBR or a CR measured by a second UE is lower than or equal to the CBR threshold or the CR threshold, or when an RSRP measured by the second UE (e.g., based on a received demodulation reference signal (DM-RS) in a physical sidelink control channel (PSCCH) or physical sidelink shared channel (PSSCH) from the first UE) is higher than or equal to the RSRP threshold, or when a distance between the second UE and the first UE (e.g., based on a measured distance or zone IDs of the second UE and the first UE) is smaller than or equal to the distance threshold, or when the absolute location accuracy of the second UE (e.g., based on global navigation satellite system (GNSS), network, or other UE(s)) is higher than or equal to the absolute location accuracy threshold, the second UE may determine that the condition is met and determine to transmit the SL-PRS transmission.

In some embodiments of the present application, the threshold(s) used for the condition based determination may be configured by the network or pre-configured for the first UE and the plurality of second UEs.

According to some other embodiments of the present application, the request information may include both the indicator to enable or disable the plurality of second UEs to perform a condition based determination on whether to transmit an SL-PRS transmission and the ID associated with a number of second UE(s). In such embodiments, all the methods, principles, and definitions for the ID and the indicator as stated in the above embodiments are also applicable.

For example, the first UE may need 4 SL-PRS transmissions from 4 second UEs whereas there are 10 second UEs that can receive the request information. In such embodiment, the first UE may determine an ID associated with a smaller number (e.g., 4 or 5) of second UEs and include the ID in the request information such that only the second UE(s) associated with the ID may transmit the SL-PRS transmission in response to the request information. Alternatively or additionally, the first UE may transmit an indicator in the request information to enable the 10 second UEs to perform a condition based determination on whether to transmit an SL-PRS transmission such that the 10 second UEs may not transmit the SL-PRS transmission if the condition is not met. For example, in the case that the RSRP measured by a second UE is lower than an RSRP threshold, the second UE may not transmit the SL-PRS transmission in response to the request information. In another example, in the case that the calculated distance between the first UE and a second UE is larger than a distance threshold, the second UE may not transmit the SL-PRS transmission in response to the request information.

When the first UE received less than 4 SL-PRS transmissions, the first UE may transmit an indicator in the request information to disable the 10 second UEs to perform a condition based determination on whether to transmit an SL-PRS transmission such that the 10 second UEs may transmit the SL-PRS transmission without considering the above conditions. Alternatively or additionally, the first UE may determine an ID associated with a larger number (e.g., 10) of second UEs and include the ID in the request information.

In some other cases (e.g., the scenarios as shown in FIGS. 3A and 3B), the first SL transmission includes an SL-PRS transmission and SCI associated with the SL-PRS transmission, each second SL transmission is a measurement report generated based on the SL-PRS transmission, and the at least one of the ID or the indicator to enable or disable the plurality of second UEs to perform a condition based determination on whether to transmit a second SL transmission in response to the first SL transmission is included in the SCI.

That is, in such cases, the first UE may transmit an SL-PRS transmission and SCI associated with the SL-PRS transmission to the plurality of second UEs in step 401. The SCI may include at least one of an ID associated with a number of second UE(s) of the plurality of second UEs or an indicator to enable or disable the plurality of second UEs to perform a condition based determination on whether to transmit a measurement report in response to the SL-PRS transmission. The SCI may include at least one of first stage SCI or second stage SCI as specified in 3GPP standard documents. Then, in step 402, the first UE may receive at least one measurement report from at least one second UE of the plurality of second UEs.

According to some embodiments of the present application, the SCI may include an ID associated with a number of second UE(s) and may not include the indicator to enable or disable the plurality of second UEs to perform a condition based determination on whether to transmit a measurement report in response to the SL-PRS transmission.

In some embodiments of the present application, the ID may be a source ID or a destination ID as specified in 3GPP standard documents.

In some other embodiments of the present application, a number of second UE(s) may be included in a group (or a set), and the ID associated with the number of second UE(s) may be a group ID of the group (or the set ID of the set) including the number of second UE(s). In such embodiments, before step 401, the first UE and the plurality of second UEs may obtain configuration information for at least one group (or set), which may be the same as that described in the above embodiments.

In some embodiments of the present application, before step 401, the first UE may determine the ID to be included in the SCI based on at least one of:
a CBR or a CR associated with a resource pool measured by the first UE;
a positioning accuracy level of the first UE;
a reporting delay requirement for the first UE; or
a number of measurement report(s) received by the first UE in response to a previous SL-PRS transmission transmitted from the first UE.

Specifically, the method for determining the ID may be similar to that described in the above embodiments for determining the ID to be included in the request information. Also, since each ID is associated with a respective number of second UE(s), the first UE may determine a number of second UE(s) from which the first UE intends to receive measurement report(s) based on at least one of the above factors, and then determine the ID to be included in the SCI based on the determined number.

After determining the ID to be included in the SCI, in step 401, the first UE may include the determined ID in the SCI associated with the SL-PRS transmission and transmit the SCI to the plurality of second UE. According to some embodiments of the present application, only UEs associated with the ID (e.g., included in a group or set associated with the ID) will transmit a measurement report in response to the SL-PRS transmission, thereby limiting the number of UEs for measurement reporting.

According to some other embodiments of the present application, the SCI may include the indicator to enable or disable the plurality of second UEs to perform a condition based determination on whether to transmit a measurement report in response to the SL-PRS transmission and may not include the ID associated with a number of second UE(s). For example, the indicator may be a 1-bit field in the SCI. A value “O” of the field may indicate to disable the plurality of second UEs to perform a condition based determination on whether to transmit a measurement report in response to the SL-PRS transmission, such that each of the plurality of second UEs may determine whether to transmit the measurement report regardless of its own condition. A value “1” of the field may indicate to enable the plurality of second UEs to perform a condition based determination on whether to transmit a measurement report in response to the SL-PRS transmission, such that each of the plurality of second UEs may determine whether to transmit the measurement report based on its own condition, for example, it may determine to transmit the measurement report when a condition is met and determine not to transmit the measurement report when the condition is not met.

In some embodiments of the present application, the condition based determination is performed based on at least one of the following thresholds: a CBR threshold or a CR threshold; an RSRP threshold; a distance threshold from the first UE; or an absolute location accuracy threshold. In some embodiments of the present application, the threshold(s) used for the condition based determination may be configured by the network or pre-configured for the first UE and the plurality of second UEs.

According to some other embodiments of the present application, the SCI may include both the indicator to enable or disable the plurality of second UEs to perform a condition based determination on whether to transmit a measurement report in response to the SL-PRS transmission and the ID associated with a number of second UE(s). In such embodiments, all the methods, principles, and definitions for the ID and the indicator as stated in the above embodiments are also applicable.

For example, the first UE may need 4 measurement reports from 4 second UEs whereas there are 10 second UEs that can receive the SL-PRS transmission and the SCI associated with the SL-PRS transmission. In such embodiment, the first UE may determine an ID associated with a smaller number (e.g., 4 or 5) of second UEs and include the ID in the SCI such that only the second UE(s) associated with the ID may transmit the measurement report in response to the SL-PRS transmission. Alternatively or additionally, the first UE may transmit an indicator in the SCI to enable the 10 second UEs to perform a condition based determination on whether to transmit a measurement report such that the 10 second UEs may not transmit the measurement report if the condition is not met. For example, in the case that the RSRP measured by a second UE is lower than an RSRP threshold, the second UE may not transmit the measurement report in response to the SL-PRS transmission. In another example, in the case that the calculated distance between the first UE to a second UE is larger than a distance threshold, the second UE may not transmit the measurement report in response to the SL-PRS transmission.

When the first UE receives less than 4 measurement reports, the first UE may transmit an indicator in the SCI to disable the 10 second UEs to perform a condition based determination on whether to transmit a measurement report such that the 10 second UEs may transmit the measurement report without considering the above conditions. Alternatively or additionally, the first UE may determine an ID associated with a larger number (e.g., 10) of second UEs and include the ID in the SCI.

FIG. 5 is a flow chart illustrating an exemplary method for SL positioning according to some embodiments of the present application. The method in FIG. 5 may be performed by a second UE (e.g., an anchor UE which helps a target UE to acquire the target UE's position). For example, the second UE may be the UE 102a, UE 102b, UE 102c, or UE 102d in FIG. 1, the UE 202b or UE 202c in FIG. 2A or FIG. 2B, or the UE 302b or UE 302c in FIG. 3A or FIG. 3B.

Referring to FIG. 5, in step 501, the second UE may receive a first SL transmission from a first UE, e.g., in a unicast manner, a broadcast manner, or a groupcast manner. The first UE may be a target UE at which a location service request is initiated or occurs, i.e., a UE that wants to know its own position.

The first SL transmission may include at least one of an ID associated with a group of UEs or an indicator to enable or disable the second UE to perform a condition based determination on whether to transmit a second SL transmission in response to the first SL transmission.

Then, in step 502, the second UE may determine whether to transmit a second SL transmission in response to the first SL transmission.

In some cases (e.g., the scenarios as shown in FIGS. 2A and 2B), the first SL transmission is request information to request an SL-PRS transmission, and the second SL transmission is an SL-PRS transmission.

That is, in such cases, the second UE may receive the request information from the first UE in step 502. The request information may include at least one of an ID associated with a group of UE(s) or an indicator to enable or disable the second UE to perform a condition based determination on whether to transmit an SL-PRS transmission in response to the request information.

In some embodiments of the present application, the request information may be received in SCI. The SCI may include at least one of first stage SCI or second stage SCI as specified in 3GPP standard documents. Consequently, the request information may be received in at least one of the first stage SCI or the second stage SCI.

According to some embodiments of the present application, the request information may include an ID associated with a group (or a set) of UEs and may not include the indicator to enable or disable the second UE to perform a condition based determination on whether to transmit an SL-PRS transmission in response to the request information.

In some embodiments of the present application, the ID may be a source ID or a destination ID as specified in 3GPP standard documents.

In some other embodiments of the present application, the ID may be a group ID (or a set ID) of the group (or the set). In such embodiment, before step 501, the second UE may obtain configuration information for at least one group (or set) of UEs, wherein each group (or set) may be associated with a respective number of UEs and a respective service (or traffic) (e.g., positioning service). Accordingly, the configuration information for each group (or set) may indicate at least one of an ID of the group (or set), one or more UEs included in the group (or set), and a service (or traffic) associated with the group (or set). In an embodiment, the configuration information may be configured by a network (e.g., BS). In another embodiment, the configuration information may be obtained based on higher layer (e.g., a layer higher than the physical layer) signaling exchanging among the first UE and a plurality of UEs including the second UE. After obtaining the configuration information, the second UE may know the group(s) (or set(s)) it belongs to.

Then, in step 502, the second UE may determine whether to transmit the SL-PRS transmission in response to the request information. For example, when the second UE is included in the group of UEs associated with the ID included in the request information, the second UE may determine to transmit the SL-PRS transmission; when the second UE is not included in the group of UEs associated with the ID included in the request information, the second UE may determine not to transmit the SL-PRS transmission.

According to some other embodiments of the present application, the request information may include the indicator to enable or disable the second UE to perform a condition based determination on whether to transmit an SL-PRS transmission in response to the request information and may not include the ID associated with a group of UE(s). For example, the indicator may be a 1-bit field in the SCI. A value “0” of the field may indicate to disable the second UE to perform a condition based determination on whether to transmit an SL-PRS transmission in response to the request information. A value “1” of the field may indicate to enable the second UE to perform a condition based determination on whether to transmit an SL-PRS transmission in response to the request information.

In an embodiment of the present application, in the case that the second UE receives the indicator to enable the second UE to perform a condition based determination on whether to transmit the SL-PRS transmission. Specifically, the second UE may determine whether to transmit the SL-PRS transmission based on whether a condition is met, for example, the second UE may determine to transmit the SL-PRS transmission when a condition is met and determine not to transmit the SL-PRS transmission when the condition is not met.

The condition based determination may be performed based on at least one of the following thresholds: a CBR threshold or a CR threshold; an RSRP threshold; a distance threshold from the first UE; or an absolute location accuracy threshold.

For example, in the case that a CBR or a CR measured by the second UE is lower than or equal to the CBR threshold or the CR threshold, the second UE may determine that the condition is met and determine to transmit the SL-PRS transmission.

Alternatively or additionally, in the case that an RSRP measured by the second UE is higher than or equal to the RSRP threshold, the second UE may determine that the condition is met and determine to transmit the SL-PRS transmission. For example, the RSRP may be measured by the second UE based on the received DM-RS in at least one PSCCH or PSSCH.

Alternatively or additionally, in the case that a distance between the first UE and the second UE (e.g., the distance may be measured by the second UE or may be determined based on the zone information of a zone in which the second UE is located) is smaller than or equal to the distance threshold, the second UE may determine that the condition is met and determine to transmit the SL-PRS transmission.

Alternatively or additionally, in the case that the absolute location accuracy of the second UE is higher than or equal to the absolute location accuracy threshold, the second UE may determine that the condition is met and determine to transmit the SL-PRS transmission. In some embodiments of the present application, the absolute location accuracy of the second UE may be determined based on the positioning methods for determining the location of the second UE. For example, the positioning methods may be based on GNSS, based on network, or based on other UE(s).

In another embodiment of the present application, in the case that the second UE receives the indicator to disable the second UE to perform the condition based determination, in step 502, the second UE may determine to transmit the SL-PRS transmission in response to the request information, without considering whether the above condition is met.

According to some other embodiments of the present application, the request information may include both the indicator to enable or disable the second UE to perform a condition based determination on whether to transmit an SL-PRS transmission in response to the request information and the ID associated with a group of UEs. In such embodiments, all the methods, principles, and definitions for the ID and the indicator as stated in the above embodiments are also applicable.

In such embodiments, after receiving the request information, in the case that the indicator enables the second UE to perform the condition based determination, in step 502, the second UE may determine to transmit the SL-PRS transmission when the second UE is included in the group of UEs associated with the ID and the condition is met, and otherwise, the second UE may not transmit the SL-PRS transmission; in the case that the indicator disables the second UE to perform the condition based determination, in step 502, the second UE may determine to transmit the SL-PRS transmission when the second UE is included in the group of UEs associated with the ID, and otherwise, the second UE may not transmit the SL-PRS transmission.

In some other cases (e.g., the scenarios as shown in FIGS. 3A and 3B), the first SL transmission includes an SL-PRS transmission and SCI associated with the SL-PRS transmission, the second SL transmission is a measurement report generated based on the SL-PRS transmission, and the at least one of the ID or the indicator to enable or disable the second UE to perform a condition based determination on whether to transmit a second SL transmission in response to the first SL transmission is included in the SCI.

That is, in such cases, the second UE may receive an SL-PRS transmission and SCI associated with the SL-PRS transmission from the first UE in step 502. The SCI may include at least one of first stage SCI or second stage SCI as specified in 3GPP standard documents. The SCI may include at least one of an ID associated with a group of UE(s) or an indicator to enable or disable the second UE to perform a condition based determination on whether to transmit a measurement report in response to the SL-PRS transmission.

According to some embodiments of the present application, the SCI may include an ID associated with a group (or a set) of UEs and may not include the indicator.

In some embodiments of the present application, the ID may be a source ID or a destination ID as specified in 3GPP standard documents.

In some other embodiments of the present application, the ID may be a group ID (or a set ID) of the group (or the set). In such embodiment, before step 501, the second UE may obtain configuration information for at least one group (or set) of UEs, which may be the same as that described in the above embodiments.

Then, in step 502, the second UE may determine whether to transmit the measurement report in response to the SL-PRS transmission. For example, when the second UE is included in the group of UEs associated with the ID included in the SCI, the second UE may determine to transmit the measurement report; when the second UE is not included in the group of UEs associated with the ID included in the SCI, the second UE may determine not to transmit the measurement report.

According to some other embodiments of the present application, the SCI may include the indicator to enable or disable the second UE to perform a condition based determination on whether to transmit a measurement report in response to the SL-PRS transmission and may not include the ID associated with a group of UE(s). For example, the indicator may be a 1-bit field in the SCI. A value “0” of the field may indicate to disable the second UE to perform a condition based determination on whether to transmit the measurement report in response to the SL-PRS transmission. A value “1” of the field may indicate to enable the second UE to perform a condition based determination on whether to transmit the measurement report in response to the SL-PRS transmission.

In an embodiment of the present application, in the case that the second UE receives the indicator to enable the second UE to perform a condition based determination on whether to transmit the measurement report. Specifically, the second UE may determine whether to transmit the measurement report based on whether a condition is met, for example, the second UE may determine to transmit the measurement report when a condition is met and determine not to transmit the measurement report when the condition is not met.

The condition based determination may be performed based on at least one of the following thresholds: a CBR threshold or a CR threshold; an RSRP threshold; a distance threshold from the first UE; or an absolute location accuracy threshold.

For example, in the case that a CBR or a CR measured by the second UE is lower than or equal to the CBR threshold or the CR threshold, the second UE may determine that the condition is met and determine to transmit the measurement report.

Alternatively or additionally, in the case that an RSRP measured by the second UE (e.g., based on the received DMRS in at least one PSCCH or PSSCH) is higher than or equal to the RSRP threshold, the second UE may determine that the condition is met and determine to transmit the measurement report.

Alternatively or additionally, in the case that a distance between the first UE and the second UE (e.g., the distance may be measured by the second UE or may be determined based on the zone information of a zone in which the second UE is located) is smaller than or equal to the distance threshold, the second UE may determine that the condition is met and determine to transmit the measurement report.

Alternatively or additionally, in the case that the absolute location accuracy of the second UE is higher than or equal to the absolute location accuracy threshold, the second UE may determine that the condition is met and determine to transmit the measurement report. In some embodiments of the present application, the absolute location accuracy of the second UE may be determined based on the positioning methods for determining the location of the second UE. For example, the positioning methods may be based on GNSS, based on network, or based on other UE(s).

In another embodiment of the present application, in the case that the second UE receives the indicator to disable the second UE to perform the condition based determination, in step 502, the second UE may determine to transmit the measurement report in response to the SL-PRS transmission, without considering whether the above condition is met.

According to some other embodiments of the present application, the SCI may include both the indicator to enable or disable the second UE to perform a condition based determination on whether to transmit a measurement report in response to the SL-PRS transmission and the ID associated with a group of UEs. In such embodiments, all the methods, principles, and definitions for the ID and the indicator as stated in the above embodiments are also applicable.

In such embodiments, after receiving the SL-PRS transmission and the associated SCI, in the case that the indicator enables the second UE to perform the condition based determination, in step 502, the second UE may determine to transmit the measurement report when the second UE is included in the group of UEs associated with the ID and the condition is met, and otherwise, the second UE may not transmit the measurement report; in the case that the indicator disables the second UE to perform the condition based determination, in step 502, the second UE may determine to transmit the measurement report when the second UE is included in the group of UEs associated with the ID, and otherwise, the second UE may not transmit the measurement report.

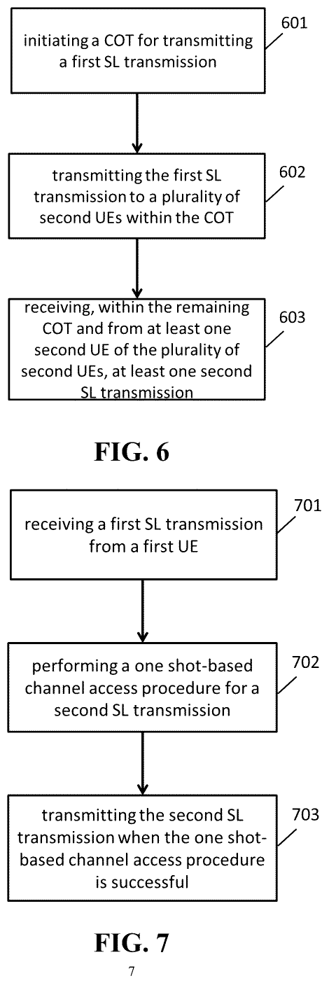

According to some embodiments of the present application, the SL-PRS transmission or the associated measurement report may be transmitted on unlicensed band. The following embodiments described with respect to FIGS. 6 and 7 illustrate how to limit the number of UEs for SL-PRS transmission or measurement reporting on unlicensed band.

FIG. 6 is a flow chart illustrating an exemplary method for SL positioning according to some other embodiments of the present application. The method in FIG. 6 may be performed by a first UE (e.g., a target UE at which a location service request is initiated or occurs, i.e., a UE that wants to know its own position). For example, the first UE may be the UE 102a, UE 102b, UE 102c, or UE 102d in FIG. 1, the UE 202a in FIG. 2A or FIG. 2B, or the UE 302a in FIG. 3A or FIG. 3B.

Referring to FIG. 6, in step 601, the first UE may initiate a COT associated with a frequency band (e.g., an unlicensed frequency band). In some embodiments, the COT may be initiated based on a listen before talk (LBT) procedure. The COT may be used for transmitting a first SL transmission. The first UE may also receive at least one second SL transmission in the COT.

In step 602, the first UE may transmit the first SL transmission to a plurality of second UEs within the COT, e.g., in a unicast manner, a broadcast manner, or a groupcast manner. The first SL transmission may include indication information which indicates a remaining COT of the COT. The remaining COT may refer to the remaining time in the COT after the first SL transmission.

Then, in step 603, the first UE may receive at least one second SL transmission in response to the first SL transmission within the remaining COT, where the at least one second SL transmission may be received from at least one second UE of the plurality of second UEs. That is, the UE may receive a corresponding second SL transmission from each of the at least one second UE. Each of the at least one second UE may be referred to as an anchor UE which helps the first UE to acquire the first UE's position.

In some cases (e.g., the scenarios as shown in FIGS. 2A and 2B), the first SL transmission may further include request information to request an SL-PRS transmission, and each second SL transmission is an SL-PRS transmission.

That is, in such cases, the first UE may transmit the request information and the indication information to the plurality of second UEs in step 602. The indication information may indicate a remaining COT of the COT.

In some embodiments of the present application, the first SL transmission (e.g., the request information and the indication information) may be transmitted in SCI. The SCI may include at least one of first stage SCI or second stage SCI as specified in 3GPP standard documents. Consequently, the request information and the indication information may be transmitted in at least one of the first stage SCI or the second stage SCI.

In some embodiments of the present application, the indication information indicating the remaining COT of the COT may be the remaining COT of the COT.

In some other embodiments of the present application, the indication information indicating the remaining COT of the COT may be a maximum number of UEs allowed to transmit an SL-PRS transmission within the remaining COT. In such embodiments, in the case that the time duration of each SL-PRS transmission is fixed or pre-configured, then each second UE may calculate the remaining COT of the COT by multiplying the time duration of each SL-PRS transmission and the maximum number indicated by the indication information.

In some other embodiments of the present application, the remaining COT of the COT may start from the end of the transmission of the request information, or start after a pre-defined offset from the end of the transmission of the request information. In some other embodiments of the present application, the remaining COT of the COT may be represented by a remaining time of SL-PRS transmission (e.g., determined by the time at which the first UE expects to receive the last SL-PRS transmission in response to the request information).

In some embodiments of the present application, after transmitting the request information and the indication information, the first UE may perform transmission for channel reservation. In an embodiment of the present application, the time duration for channel reservation may be pre-defined or determined based on a processing time of the first UE.

Then, in step 603, the first UE may receive at least one SL-PRS transmission from at least one second UE of the plurality of second UEs within the remaining COT. For example, in the case that the indication information is the remaining COT, after performing transmission for channel reservation, the first UE may start a timer which has a time length equal to the remaining COT (e.g., the remaining COT may start from the end of the transmission for channel reservation), and the first UE may receive SL-PRS transmission(s) until the timer is reduced to zero (i.e., the timer expires). In another example, in the case that the indication information is a maximum number of UEs allowed to transmit an SL-PRS transmission within the remaining COT, after performing transmission for channel reservation, the first UE may set an initial value of a counter to be the maximum number of UEs and decrement the counter by one upon each receipt of an SL-PRS transmission, and the first UE may receive SL-PRS transmission(s) until the counter is reduced to zero.

In some other cases (e.g., the scenarios as shown in FIGS. 3A and 3B), the first SL transmission includes an SL-PRS transmission and SCI associated with the SL-PRS transmission, each second SL transmission is a measurement report generated based on the SL-PRS transmission, and the indication information is included in the SCI.

That is, in such cases, the first UE may transmit an SL-PRS transmission and SCI associated with the SL-PRS transmission to the plurality of second UEs in step 602. The SCI may include at least one of first stage SCI or second stage SCI as specified in 3GPP standard documents. The SCI may include the indication information which indicates a remaining COT of the COT.

In some embodiments of the present application, the indication information indicating the remaining COT of the COT may be the remaining COT of the COT.

In some other embodiments of the present application, the indication information indicating the remaining COT of the COT may be a maximum number of UEs allowed to transmit a measurement report within the remaining COT. In such embodiments, in the case that the time duration of each measurement report transmission is fixed or pre-configured, then each second UE may calculate the remaining COT of the COT by multiplying the time duration of each measurement report transmission and the maximum number indicated by the indication information.

In some other embodiments of the present application, the remaining COT of the COT may start from the end of the transmission of the SL-PRS transmission, or start after a pre-defined offset from the end of the transmission of the SL-PRS transmission. In some other embodiments of the present application, the remaining COT of the COT may be represented by a remaining time of measurement report transmission (e.g., determined by the time at which the first UE expects to receive the last measurement report in response to the SL-PRS transmission).

In some embodiments of the present application, after transmitting the SL-PRS transmission and the SCI associated with the SL-PRS transmission, the first UE may perform transmission for channel reservation. In an embodiment of the present application, the time duration for channel reservation may be pre-defined or determined based on based on a processing time of the first UE.

Then, in step 603, the first UE may receive at least one measurement report from at least one second UE of the plurality of second UEs within the remaining COT. For example, in the case that the indication information is the remaining COT, after performing transmission for channel reservation, the first UE may start a timer which has a time length equal to the remaining COT (e.g., the remaining COT may start from the end of the transmission for channel reservation), and the first UE may receive measurement report(s) until the timer is reduced to zero (i.e., the timer expires). In another example, in the case that indication information is a maximum number of UEs allowed to transmit a measurement report within the remaining COT, after performing transmission for channel reservation, the first UE may set an initial value of a counter to be the maximum number of UEs and decrement the counter by one upon each receipt of a measurement report, and the first UE may receive measurement report(s) until the counter is reduced to zero.

FIG. 7 is a flow chart illustrating an exemplary method for SL positioning according to some other embodiments of the present application. The method in FIG. 7 may be performed by a second UE (e.g., an anchor UE which helps a target UE to acquire the target UE's position). For example, the second UE may be the UE 102a, UE 102b, UE 102c, or UE 102d in FIG. 1, the UE 202b or UE 202c in FIG. 2A or FIG. 2B, or the UE 302b or UE 302c in FIG. 3A or FIG. 3B.

Referring to FIG. 7, in step 701, the second UE may receive a first SL transmission from a first UE, e.g., in a unicast manner, a broadcast manner, or a groupcast manner. The first UE may be a target UE at which a location service request is initiated or occurs, i.e., a UE that wants to know its own position. The first SL transmission may include indication information which indicates a remaining COT of a COT initiated by the first UE (e.g., the COT is initiated for transmitting the first SL transmission).

Then, in step 702, the second UE may perform a one shot-based channel access procedure for a second SL transmission in response to the first SL transmission within the remaining COT. In the case that the one shot-based channel access procedure is successful, in step 703, the second UE may transmit the second SL transmission to the first UE. The second UE may repeat the one shot-based channel access procedure until it is successful or the COT ends.

In some cases (e.g., the scenarios as shown in FIGS. 2A and 2B), the first SL transmission may further include request information to request an SL-PRS transmission, and the second SL transmission is an SL-PRS transmission.

That is, in such cases, the second UE may receive the request information and the indication information from the first UE in step 701. The indication information may indicate a remaining COT of the COT.

In some embodiments of the present application, the first SL transmission (e.g., the request information and the indication information) may be received in SCI. The SCI may include at least one of first stage SCI or second stage SCI as specified in 3GPP standard documents. Consequently, the request information and the indication information may be received in at least one of the first stage SCI or the second stage SCI.

In some embodiments of the present application, the indication information indicating the remaining COT of the COT may be the remaining COT of the COT.

In some other embodiments of the present application, the indication information indicating the remaining COT of the COT may be a maximum number of UEs allowed to transmit an SL-PRS transmission within the remaining COT. In such embodiments, in the case that the time duration of each SL-PRS transmission is fixed or pre-configured, then the second UE may calculate the remaining COT of the COT by multiplying the time duration of each SL-PRS transmission and the maximum number indicated by the indication information.

In some other embodiments of the present application, the remaining COT of the COT may start from the end of the transmission of the request information, or start after a pre-defined offset from the end of the transmission of the request information. In some other embodiments of the present application, the remaining COT of the COT may be represented by a remaining time of SL-PRS transmission (e.g., determined by the time at which the first UE expects to receive the last SL-PRS transmission in response to the request information).

In some embodiments of the present application, after receiving the request information and the indication information, in step 702, the second UE may perform a one shot-based channel access procedure within the remaining COT. When the one shot-based channel access procedure is successful within the remaining COT, in step 703, the second UE may transmit the SL-PRS transmission to the first UE.

For example, in the case that the indication information is the remaining COT, after receiving the indication information, the second UE may start a timer which has a time length equal to the remaining COT, and perform the one shot-based channel access procedure until it is successful or the timer is reduced to zero (i.e., the timer expires). In the case that the one shot-based channel access procedure is successful before the timer is reduced to zero, the second UE may transmit the SL-PRS transmission to the first UE. In the case that the one shot-based channel access procedure is not successful when the timer is reduced to zero, the second UE may not transmit the SL-PRS transmission.

In another example, in the case that the indication information is a maximum number of UEs allowed to transmit an SL-PRS transmission within the remaining COT, after receiving the indication information, the second UE may set an initial value of a counter to be the maximum number of UEs and decrement the counter by one upon each failure of the one shot-based channel access procedure. In the case that the one shot-based channel access procedure is successful before the counter is reduced to zero, the second UE may transmit the SL-PRS transmission to the first UE. In the case that the one shot-based channel access procedure is not successful when the counter is reduced to zero, the second UE may not transmit the SL-PRS transmission.

In some other cases (e.g., the scenarios as shown in FIGS. 3A and 3B), the first SL transmission includes an SL-PRS transmission and SCI associated with the SL-PRS transmission, the second SL transmission is a measurement report generated based on the SL-PRS transmission, and the indication information is included in the SCI.

That is, in such cases, the second UE may receive an SL-PRS transmission and SCI associated with the SL-PRS transmission from the first UE in step 701. The SCI may include at least one of first stage SCI or second stage SCI as specified in 3GPP standard documents. The SCI may include the indication information which indicates a remaining COT of the COT.

In some embodiments of the present application, the indication information indicating the remaining COT of the COT may be the remaining COT of the COT.

In some other embodiments of the present application, the indication information indicating the remaining COT of the COT may be a maximum number of UEs allowed to transmit a measurement report within the remaining COT. In such embodiments, in the case that the time duration of each measurement report transmission is fixed or pre-configured, then the second UE may calculate the remaining COT of the COT by multiplying the time duration of each measurement report transmission and the maximum number indicated by the indication information.

In some other embodiments of the present application, the remaining COT of the COT may start from the end of the transmission of the SL-PRS transmission, or start after a pre-defined offset from the end of the transmission of the SL-PRS transmission. In some other embodiments of the present application, the remaining COT of the COT may be represented by a remaining time of measurement report transmission (e.g., determined by the time at which the first UE expects to receive the last measurement report in response to the SL-PRS transmission).

After receiving the SL-PRS transmission and the SCI, the second UE may perform measurement on the SL-PRS transmission to generate a measurement report associated with the SL-PRS transmission.

Then, in step 702, the second UE may perform a one shot-based channel access procedure within the remaining COT for transmitting the measurement report. When the one shot-based channel access procedure is successful within the remaining COT, in step 703, the second UE may transmit the measurement report to the first UE.

For example, in the case that the indication information is the remaining COT, after receiving the indication information, the second UE may start a timer which has a time length equal to the remaining COT, and perform the one shot-based channel access procedure until it is successful or the timer is reduced to zero (i.e., the timer expires). In the case that the one shot-based channel access procedure is successful before the timer is reduced to zero, the second UE may transmit the measurement report to the first UE. In the case that the one shot-based channel access procedure is not successful when the timer is reduced to zero, the second UE may not transmit the measurement report.

In another example, in the case that indication information is a maximum number of UEs allowed to transmit an measurement report within the remaining COT, after receiving the indication information, the second UE may set an initial value of a counter to be the maximum number of UEs and decrement the counter by one upon each failure of the one shot-based channel access procedure. In the case that the one shot-based channel access procedure is successful before the counter is reduced to zero, the second UE may transmit the measurement report to the first UE. In the case that the one shot-based channel access procedure is not successful when the counter is reduced to zero, the second UE may not transmit the measurement report.

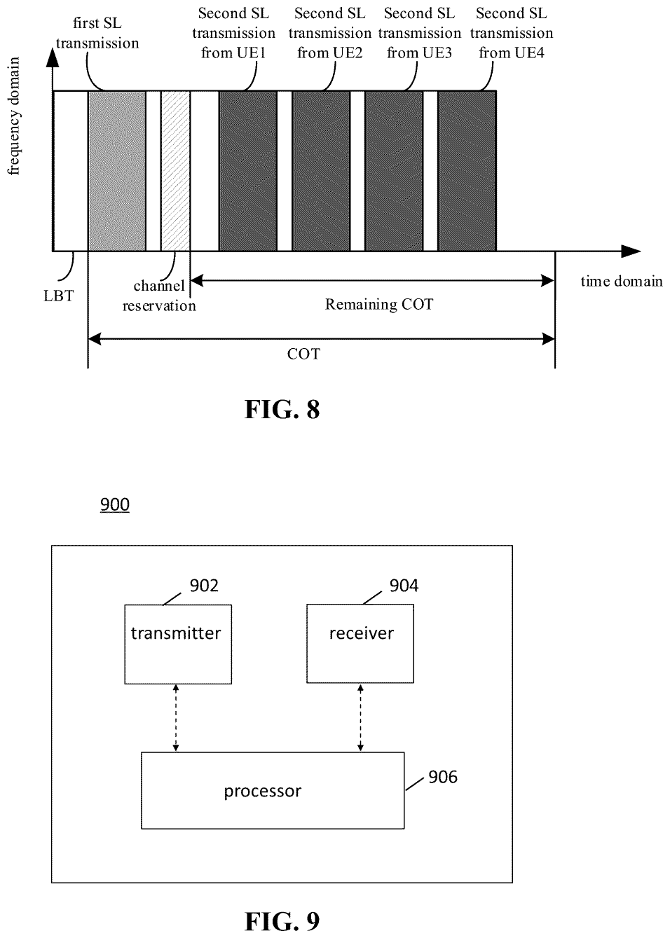

FIG. 8 illustrates an exemplary timing diagram for SL positioning according to some embodiments of the present application.

Referring to FIG. 8, at the beginning, the first UE may perform an LBT procedure. During the LBT procedure, the first UE may sense resources for transmitting a first SL transmission. Then, based on the LBT procedure, the first UE may initiate a COT for transmitting the first SL transmission. After that, the first UE may transmit the first SL transmission to a plurality of second UEs, e.g., 10 second UEs indexed with UE1 to UE10. The first SL transmission may include indication information which indicates a remaining COT of the COT initiated by the first UE.

After that, the first UE may perform transmission for channel reservation. Then, the first UE may receive at least one second SL transmission within the remaining COT. For example, the first UE may start a timer which has a time length equal to the remaining COT and receive the second SL transmission(s) until the timer is reduced to 0. In the example shown in FIG. 8, the first UE receives 4 second SL transmissions from 4 UEs (e.g., UE1, UE2, UE3, and UE4) within the remaining COT.

Specifically, the 10 second UEs may receive the first SL transmission. After receiving the first SL transmission, each second UE may determine the remaining COT for transmitting a second SL transmission. Before transmitting the second SL transmission, each second UE needs to perform a one shot-based channel access procedure within the remaining COT. For example, each second UE may start a timer which has a time length equal to the remaining COT and perform the one shot-based channel access procedure until it is successful or the timer is reduced to 0.

In the example shown in FIG. 8, UE1 first successfully performs the one shot-based channel access procedure, and it may first transmit the second SL transmission to the first UE. Then, UE2 successfully performs the one shot-based channel access procedure, and it may transmit the second SL transmission to the first UE. After that, UE3 and UE4 successfully perform the one shot-based channel access procedure in sequence, and they may transmit the second SL transmissions to the first UE in sequence. After that, none of the second UEs performs the one shot-based channel access procedure successfully within the remaining COT, and thus no more second UE transmits the second SL transmission to the first UE.

In the embodiments of FIG. 8, the first SL transmission may include request information and the indication information and each second SL transmission may be an SL-PRS transmission. Alternatively, the first SL transmission may include an SL-PRS transmission and SCI (including the indication information) associated with the SL-PRS transmission, and each second SL transmission may be a measurement report.

In some embodiments of the present disclosure, the first SL transmission described with respect to FIGS. 6, 7, and 8 may also include at least one of an ID associated with a number of second UE(s) of the plurality of second UEs or an indicator to enable or disable the plurality of second UEs to perform a condition based determination on whether to transmit a second SL transmission in response to the first SL transmission.

FIG. 9 illustrates a simplified block diagram of an exemplary apparatus 900 for SL positioning according to some embodiments of the present application. The apparatus 900 may be a first UE (e.g., a target UE) or a second UE (e.g., an anchor UE) as described above.

Referring to FIG. 9, the apparatus 900 may include at least one transmitter 902, at least one receiver 904, and at least one processor 906. The at least one transmitter 902 is coupled to the at least one processor 906, and the at least one receiver 904 is coupled to the at least one processor 906.

Although in this figure, elements such as the transmitter 902, the receiver 904, and the processor 906 are illustrated in the singular, the plural is contemplated unless a limitation to the singular is explicitly stated. In some embodiments of the present application, the transmitter 902 and the receiver 904 may be combined to one device, such as a transceiver. In some embodiments of the present application, the apparatus 900 may further include an input device, a memory, and/or other components. The transmitter 902, the receiver 904, and the processor 906 may be configured to perform any of the methods described herein (e.g., the method described with respect to any of FIGS. 4-8).

According to some embodiments of the present application, the apparatus 900 may be a first UE, and the transmitter 902, the receiver 904, and the processor 906 may be configured to perform operations of the method as described with respect to FIG. 4. For example, the transmitter 902 may be configured to transmit a first SL transmission to a plurality of second UEs, wherein the first SL transmission includes at least one of an ID associated with a number of second UE(s) of the plurality of second UEs or an indicator to enable or disable the plurality of second UEs to perform a condition based determination on whether to transmit a second SL transmission in response to the first SL transmission. The receiver 904 may be configured to receive, from at least one second UE of the plurality of second UEs, at least one second SL transmission in response to the first SL transmission. In some embodiments, the processor 906 may be configured to determine the ID or the number based on at least one of: a CBR or a CR associated with a resource pool measured by the first UE; a positioning accuracy level of the first UE; a reporting delay requirement for the first UE; or a number of second SL transmission(s) received by the first UE in response to a previous first SL transmission transmitted from the first UE.

According to some embodiments of the present application, the apparatus 900 may be a second UE, and the transmitter 902, the receiver 904, and the processor 906 may be configured to perform operations of the method as described with respect to FIG. 5. For example, the receiver 904 may be configured to receive a first SL transmission from a first UE, wherein the first SL transmission includes at least one of an ID associated with a group of UEs or an indicator to enable or disable the second UE to perform a condition based determination on whether to transmit a second SL transmission in response to the first SL transmission. The processor 906 may be configured to determine whether to transmit a second SL transmission in response to the first SL transmission.

According to some embodiments of the present application, the apparatus 900 may be a first UE, and the transmitter 902, the receiver 904, and the processor 906 may be configured to perform operations of the methods as described with respect to FIGS. 6 and 8. For example, the processor 906 may be configured to initiate a COT for transmitting a first SL transmission. The transmitter 902 may be configured to transmit the first SL transmission to a plurality of second UEs within the COT, wherein the first SL transmission includes indication information which indicates a remaining COT of the COT. The receiver 904 may be configured to receive, within the remaining COT and from at least one second UE of the plurality of second UEs, at least one second SL transmission in response to the first SL transmission.

According to some embodiments of the present application, the apparatus 900 may be a second UE, and the transmitter 902, the receiver 904, and the processor 906 may be configured to perform operations of the methods as described with respect to FIGS. 7 and 8. For example, the receiver 904 may be configured to receive a first SL transmission from a first UE, wherein the first SL transmission includes indication information which indicates a remaining COT of a COT initiated by the first UE. The processor 906 may be configured to perform a one shot-based channel access procedure for a second SL transmission in response to the first SL transmission within the remaining COT. The transmitter 902 may be configured to transmit the second SL transmission when the one shot-based channel access procedure is successful.

In some embodiments of the present application, the apparatus 900 may further include at least one non-transitory computer-readable medium. In some embodiments of the present disclosure, the non-transitory computer-readable medium may have stored thereon computer-executable instructions to cause the processor 906 to implement any of the methods as described above. For example, the computer-executable instructions, when executed, may cause the processor 906 to interact with the transmitter 902 and/or the receiver 904, so as to perform operations of the methods, e.g., as described with respect to FIGS. 4-8.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for SL positioning, including a processor and a memory. Computer programmable instructions for implementing a method for SL positioning are stored in the memory, and the processor is configured to perform the computer programmable instructions to implement the method for SL positioning. The method for SL positioning may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for SL positioning according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A first user equipment (UE) for wireless communication, comprising:
at least one memory; and
at least one processor coupled with the at least one memory and configured to cause the first UE to:
transmit a first sidelink (SL) transmission to a plurality of second UEs, wherein the first SL transmission includes at least one of an identity (ID) associated with a number of second UEs of the plurality of second UEs or an indicator to enable or disable the plurality of second UEs to perform a condition based determination on whether to transmit a second SL transmission in response to the first SL transmission; and
receive, from at least one second UE of the plurality of second UEs, at least one second SL transmission in response to the first SL transmission.

2. The first UE of claim 1, wherein the first SL transmission is request information to request an SL positioning reference signal (SL-PRS) transmission, and wherein each second SL transmission is an SL-PRS transmission.

3. The first UE of claim 2, wherein the request information is transmitted in sidelink control information (SCI).

4. The first UE of claim 1, wherein the first SL transmission includes an SL-PRS transmission and SCI associated with the SL-PRS transmission, wherein each second SL transmission is a measurement report generated based on the SL-PRS transmission, and wherein the at least one ID or the indicator is included in the SCI.

5. The first UE of claim 1, wherein the at least one_processor is further configured to cause the first UE to determine the ID or the number based on at least one of:
a channel busy ratio (CBR) or a channel occupancy ratio (CR) associated with a resource pool measured by the first UE;
a positioning accuracy level of the first UE;
a reporting delay requirement for the first UE; or
a number of second SL transmissions received by the first UE in response to a previous first SL transmission transmitted from the first UE.

6. The first UE of claim 1, wherein the condition based determination is performed based on at least one of:
a channel busy ratio (CBR) threshold or a channel occupancy ratio (CR) threshold;
a reference signal receiving power threshold;
a distance threshold from the first UE; or
an absolute location accuracy threshold.

7. A second user equipment (UE) for wireless communication, comprising:
at least one memory; and
at least one processor coupled with the at least one memory and configured to cause the second UE to:
receive a first sidelink (SL) transmission from a first UE, wherein the first SL transmission includes at least one of an identity (ID) associated with a group of UEs or an indicator to enable or disable the second UE to perform a condition based determination on whether to transmit a second SL transmission in response to the first SL transmission; and
determine whether to transmit a second SL transmission in response to the first SL transmission.

8. The second UE of claim 7, wherein the first SL transmission is request information to request an SL positioning reference signal (SL-PRS) transmission, and wherein the second SL transmission is an SL-PRS transmission.

9. The second UE of claim 7, wherein the first SL transmission includes the indicator but does not include the ID, and wherein the at least one processor is further configured to cause the second UE to:
when the indicator enables the second UE to perform the condition based determination, determine to transmit the second SL transmission when a condition is met; and
when the indicator disables the second UE to perform the condition based determination, determine to transmit the second SL transmission.

10. The second UE of claim 7, wherein the first SL transmission includes both the indicator and the ID, and wherein the at least one processor is further configured to:
when the indicator enables the second UE to perform the condition based determination, determine to transmit the second SL transmission when the second UE is included in the group of UEs and a condition is met; and
when the indicator disables the second UE to perform the condition based determination, determine to transmit the second SL transmission when the second UE is included in the group of UEs.

11. A first user equipment (UE) for wireless communication, comprising:
at least one memory; and
at least one processor coupled with the at least one memory and configured to cause the first UE to:
initiate a channel occupancy time (COT) for transmitting a first sidelink (SL) transmission;
transmit the first SL transmission to a plurality of second UEs within the COT, wherein the first SL transmission includes indication information which indicates a remaining COT of the COT; and
receive, within the remaining COT and from at least one second UE of the plurality of second UEs, at least one second SL transmission in response to the first SL transmission.

12. The first UE of claim 11, wherein the first SL transmission further includes request information to request an SL positioning reference signal (SL-PRS) transmission, and wherein each second SL transmission is an SL-PRS transmission.

13. The first UE of claim 12, wherein the first SL transmission is transmitted in sidelink control information (SCI).

14. The first UE of claim 11, wherein the first SL transmission includes an SL-PRS transmission and SCI associated with the SL-PRS transmission, wherein each second SL transmission is a measurement report generated based on the SL-PRS transmission, and wherein the indication information is included in the SCI.

15. The first UE of claim 11, wherein the indication information is the remaining COT or a maximum number of UEs allowed to transmit a second SL transmission within the remaining COT.

16. A processor for wireless communication, comprising:
at least one controller coupled with at least one memory and configured to cause the processor to:
transmit a first sidelink (SL) transmission to a plurality of second UEs, wherein the first SL transmission includes at least one of an identity (ID) associated with a number of second UEs of the plurality of second UEs or an indicator to enable or disable the plurality of second UEs to perform a condition based determination on whether to transmit a second SL transmission in response to the first SL transmission; and
receive, from at least one second UE of the plurality of second UEs, at least one second SL transmission in response to the first SL transmission.

17. The processor of claim 16, wherein the first SL transmission is request information to request an SL positioning reference signal (SL-PRS) transmission, and wherein each second SL transmission is an SL-PRS transmission.

18. The processor of claim 16, wherein the request information is transmitted in sidelink control information (SCI).

19. The processor of claim 16, wherein the at least one controller is further configured to cause the processor to determine the ID or the number based on at least one of:
a channel busy ratio (CBR) or a channel occupancy ratio (CR) associated with a resource pool measured by the processor;
a positioning accuracy level of the processor;
a reporting delay requirement for the processor; or
a number of second SL transmissions received by the processor in response to a previous first SL transmission transmitted from the processor.

20. The processor of claim 16, wherein the condition based determination is performed based on at least one of:
a channel busy ratio (CBR) threshold or a channel occupancy ratio (CR) threshold;
a reference signal receiving power threshold;
a distance threshold from the processor; or
an absolute location accuracy threshold.
